(19) United States
(12) Patent Application Publication
(10) Pub. No.: US 2024/0276459 A1
(43) Pub. Date: Aug. 15, 2024

(54) METHOD FOR WIRELESS COMMUNICATION, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Yi Zhang, Dongguan (CN)

(21) Appl. No.: 18/640,946

(22) Filed: Apr. 19, 2024

Related U.S. Application Data
(63) Continuation of application No. PCT/CN2021/125914, filed on Oct. 22, 2021.

(51) Int. Cl. H04W 72/044; H04L 1/00

(52) U.S. Cl. CPC H04W 72/044; H04L 1/0013

(57) ABSTRACT

A method for wireless communication, a terminal device, and a network device are provided in embodiments of the disclosure. The method includes receiving first information. The first information is used to configure or indicate a first resource, and the first resource is not used for transmission or reception of a first physical channel.

### CROSS-REFERENCE TO RELATED APPLICATION(S)

This application is a continuation of International Application No. PCT/CN2021/125914, filed Oct. 22, 2021, the entire disclosure of which is hereby incorporated by reference.

### TECHNICAL FIELD

This disclosure relates to the field of communications, and more specifically, to a method for wireless communication, a terminal device, and a network device.

### RELATED ART

In a new radio (NR) system, a terminal device needs to receive many downlink (DL) reference signals (RSs) and/or DL physical channels to assist the terminal device in processes such as synchronization, reception of control information, and channel measurement. In addition, the terminal device also needs to transmit many uplink (UL) RSs or UL physical channels to assist a network device in performing scheduling and other operations on the terminal device, where such a type of signals and/or channels play a very important role in the system and are usually sent periodically within a period configured by higher-layer signaling or predefined by the specification.

However, in the case where a UL scheduling grant or a DL scheduling grant for data is performed via downlink control information (DCI), generally, only a whole block of time-frequency resources may be allocated to save DCI overhead. In this case, if the above type of signals and/or channels are simultaneously received on the resources allocated via the DCI, data sent may interfere with reception of the type of signals or information, which in turn reduces a system performance.

Therefore, there is an urgent need in the field for a method for wireless communication that can reduce reception interference, thereby improving a system performance.

### SUMMARY

A method for wireless communication, a terminal device, and a network device are provided in embodiments of the disclosure.

In a first aspect, a method for wireless communication is provided in the disclosure. The method includes receiving first information. The first information is used to configure or indicate a first resource, and the first resource is not used for transmission or reception of a first physical channel.

In a second aspect, a terminal device is provided in the disclosure. The terminal device includes a transceiver, a processor coupled to the transceiver, and a memory storing computer programs which, when executed by the processor, cause the transceiver to receive first information. The first information is used to configure or indicate a first resource, and the first resource is not used for transmission or reception of a first physical channel.

In a third aspect, a network device is provided in the disclosure. The network device includes a transceiver, a processor coupled to the transceiver, and a memory storing computer programs which, when executed by the processor, cause the transceiver to transmit first information. The first information is used to configure or indicate a first resource, and the first resource is not used for transmission or reception of a first physical channel.

Other features and aspects of the disclosed features will become apparent from the following detailed description, taken in conjunction with the accompanying drawings, which illustrate, by way of example, the features in accordance with implementations the disclosure. The summary is not intended to limit the scope of any implementations described herein.

### BRIEF DESCRIPTION OF THE DRAWINGS

FIG. 1 illustrates an example of a communication system to which the disclosure is applicable.

FIG. 2 is a schematic diagram illustrating a flexible time division duplex (TDD) slot format provided in embodiments of the disclosure.

FIG. 3 illustrates an example of flexible TDD resource mapping provided in embodiments of the disclosure.

FIGS. 4 to 7 illustrate examples of full-duplex communication-based resource formats provided in embodiments of the disclosure.

FIG. 8 is a schematic flow chart illustrating a method for wireless communication provided in embodiments of the disclosure.

FIG. 9 illustrates an example of a first resource that is not used for transmission or reception of a first physical channel, provided in embodiments of the disclosure.

FIG. 10 is a schematic block diagram illustrating a terminal device provided in embodiments of the disclosure.

FIG. 11 is a schematic block diagram illustrating a network device provided in embodiments of the disclosure.

FIG. 12 is a schematic block diagram illustrating a communication device provided in embodiments of the disclosure.

FIG. 13 is a schematic block diagram illustrating a chip provided in embodiments of the disclosure.

### DETAILED DESCRIPTION

The following will illustrate technical solutions of embodiments of the disclosure with reference to accompanying drawings of embodiments of the disclosure. Apparently, embodiments illustrated herein are merely some, rather than all embodiments, of the disclosure. Based on the embodiments of the disclosure, all other embodiments obtained by those of ordinary skill in the art without creative effort shall fall within the protection scope of the disclosure.

FIG. 1 illustrates an example of a system architecture in embodiments of the disclosure.

As illustrated in FIG. 1, a communication system 100 may include a terminal device 110 and a network device 120. The network device 120 can communicate with the terminal device 110 via an air interface. The terminal device 110 and the network device 120 support a multi-service transmission.

It can be understood that, in embodiments of the disclosure, the communication system 100 is used simply for exemplarily illustration rather than limitation. That is, the technical solutions of embodiments of the disclosure are applicable to various communication systems. The various communication systems may include a long term evolution (LTE) system, an LTE time division duplex (TDD) system, a universal mobile telecommunication system (UMTS), an internet of things (IoT) system, a narrow band-internet of things (NB-IoT) system, an enhanced machine-type communications (eMTC) system, a 5th generation (5G) communication system (also referred to as a new radio (NR) communication system), or a future communication system.

In the communication system 100 as illustrated in FIG. 1, the network device 120 may be an access network device that communicates with the terminal device 110. The access network device can provide a communication coverage for a specific geographic area and communicate with terminal devices 110 (e.g., a user equipment (UE)) in the coverage area.

The network device 120 may be an evolved NodeB (eNB or eNodeB) in the LTE system, a next generation radio access network (NG RAN) device, a gNB in the NR system, or a radio controller in a cloud radio access network (CRAN). Alternatively, the network device 120 may also be a relay station, an access point (AP), an in-vehicle device, a wearable device, a hub, a switch, a bridge, a router, or a network device in a future evolved public land mobile network (PLMN).

The terminal device 110 may be any terminal device, which includes, but is not limited to, a terminal device that connects to the network device 120 or other terminal devices in a wired or wireless manner.

For example, the terminal device 110 may be referred to as an access terminal, a UE, a subscriber unit, a subscriber station, a mobile station, a remote station, a remote terminal, a mobile device, a user terminal, a terminal, a wireless communication device, a user agent, a user device, etc. The access terminal may be a cellular radio telephone, a cordless telephone, a session initiation protocol (SIP) telephone, an IoT device, a satellite handheld terminal, a wireless local loop (WLL) station, a personal digital assistant (PDA), a handheld device with wireless communication functions, a computing device, other processing devices coupled with a wireless modem, an in-vehicle device, a wearable device, or a terminal device in a 5G network, a terminal device in a future evolved network, etc.

The terminal device 110 can be configured for device to device (D2D) communication.

The wireless communication system 100 may further include a core network device 130 that communicates with a base station. The core network device 130 may be a 5G core (5GC) device, an access and mobility management function (AMF) device, an authentication server function (AUSF) device, a user plane function (UPF) device, or a session management function (SMF) device. Optionally, the core network device 130 may also be an evolved packet core (EPC) device in the LTE network such as a session management function+core packet gateway (SMF+PGW-C) device. It can be understood that, the SMF+PGW-C device can implement functions of both SMF and PGW-C. With the evolution of the network, the core network device may also have other names, or a new network entity can be formed by dividing functions of the core network, which will not be limited herein.

Various functional units in the communication system 100 may establish a connection with one another via a next generation (NG) interface for communication.

For example, the terminal device establishes an air interface connection with the access network device via an NR interface to transmit user-plane data and control-plane signaling. The terminal device can establish a control-plane signaling connection with the AMF device via NG interface 1 (N1 for short). The access network device, e.g., a next generation wireless access base station (gNB), can establish a user-plane data connection with the UPF device via NG interface 3 (N3 for short). The access network device can establish a control-plane signaling connection with the AMF device via NG interface 2 (N2 for short). The UPF device can establish a control-plane signaling connection with the SMF device via NG interface 4 (N4 for short). The UPF device can exchange user-plane data with a data network via NG interface 6 (N6 for short). The AMF device can establish a control-plane signaling connection with the SMF device via NG interface 11 (N11 for short). The SMF device can establish a control-plane signaling connection with a policy control function (PCF) device via NG interface 7 (N7 for short).

FIG. 1 exemplarily illustrates a base station, a core network device, and two terminal devices. Optionally, the wireless communication system 100 may include multiple base stations and the other number of terminal devices that may be included in a coverage range of each of the multiple base stations, which will not be limited in embodiments of the disclosure.

It can be understood that, a device with a communication function in a network/system in embodiments of the disclosure can be referred to as a communication device. The communication system 100 illustrated in FIG. 1 is illustrated as an example, the communication device may include the network device 120 and the terminal device 110 that have communication functions, and the network device 120 and the terminal device 110 may be the above-mentioned devices, which will not be repeated herein. The communication device may further include other devices in the communication system 100, e.g., a network controller, a mobile management entity (MME), or other network entities, which will not be limited in embodiments of the disclosure.

It should be understood that, the terms “system” and “network” herein are usually interchangeable. The term “and/or” herein is used to describe an association relationship between associated objects and represents that three relationships may exist. For example, A and/or B may represent the following three cases: only A exists, both A and B exist, and only B exists. The character “/” herein generally indicates an “or” relationship between the associated objects.

In order to facilitate understanding of the solutions provided in the disclosure, relevant contents of flexible TDD are explained below.

In flexible TDD, a flexible slot format may be adopted, i.e., a downlink (DL) symbol, a flexible symbol, and an uplink (UL) symbol may be included in a single slot, where a symbol direction of the flexible symbol is undefined, and the flexible symbol can be changed to a DL symbol or a UL symbol via other signaling. In addition, in NR, various flexible slot formats are defined, including a full DL slot, a full UL slot, a full flexible slot, and slot formats with different numbers of DL symbols, UL symbols, and flexible symbols.

A network device may configure a flexible slot format for a terminal device through a semi-static UL-DL configuration and/or a dynamic UL-DL configuration.

Specifically, the semi-static UL-DL configuration includes tdd-UL-DL-ConfigurationCommon and tdd-UL-DL-ConfigurationDedicated, where tdd-UL-DL-ConfigurationCommon is a cell-level slot format configuration and tdd-UL-DL-ConfigurationDedicated is a UE-specific slot format configuration.

Configuration parameters in tdd-UL-DL-ConfigurationCommon or tdd-UL-DL-ConfigurationDedicated include, but are not limited to: a reference subcarrier spacing μ_{ref}, a period P, the number of DL slots dₛₗₒₜₛ, the number of DL symbols d_{sym}, the number of UL slots uₛₗₒₜₛ, and the number of UL symbols u_{sym}. The reference subcarrier spacing μ_{ref} may be used to determine a slot length, and thus the total number of slots in the period P, S, may be determined according to the reference subcarrier spacing μ_{ref}and the period P. First dₛₗₒₜₛ slots in the S slots denote full DL slots, and first d_{sym} symbols in a slot after the last full DL slot denote DL symbols. Last uₛₗₒₜₛ slots in the S slots denote full UL slots, last u_{sym} symbols in a slot before the first full UL slot denote UL symbols, and the remaining symbols in the period P denote flexible symbols.

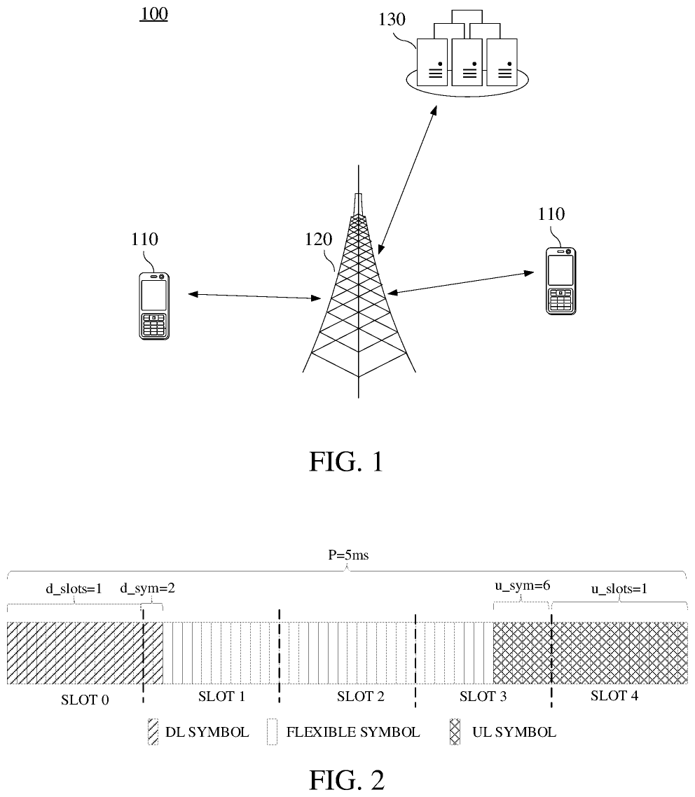

FIG. 2 is a schematic diagram illustrating a flexible TDD slot format provided in embodiments of the disclosure.

As illustrated in FIG. 2, in the case of μ_{ref}=15 KHz and P=5 ms, the terminal device may determine, according to μ_{ref} and the period P, that the total number of slots in the period P is 4, where dₛₗₒₜₛ=1, d_{sym}=2, uₛₗₒₜₛ=1, and u_{sym}=6. The values illustrated in FIG. 2 are merely examples of the disclosure, and may not be understood as limitations to the disclosure.

In addition, the dynamic UL-DL configuration includes a slot format indicator (SFI), where the SFI may dynamically indicate a slot format per slot. The SFI can be used to configure only a direction of a flexible symbol that is configured through the semi-static UL-DL configuration, such as a flexible symbol illustrated in FIG. 2. The SFI cannot be used to change directions of both a UL symbol and a DL symbol that are configured via semi-static configuration information, such as a UL symbol and a DL symbol illustrated in FIG. 2.

Benefits of the flexible TDD include dynamic adaptation to UL and DL services in a network, reduction in delay, and good forward compatibility.

A direction of a flexible slot and/or a flexible symbol in the flexible TDD can be flexibly configured as a UL direction or a DL direction. However, in the case where a flexible symbol is indicated as a DL symbol and the network device and the terminal device adopt a half-duplex operation mode, the terminal device can perform only reception in the DL symbol, and the network device can perform only transmission in the DL symbol. In the case where a flexible symbol is indicated as a UL symbol and the network device and the terminal device adopt the half-duplex operation mode, the terminal device can perform only transmission in the UL symbol. That is to say, the network device cannot simultaneously perform transmission and reception in the UL symbol or the DL symbol.

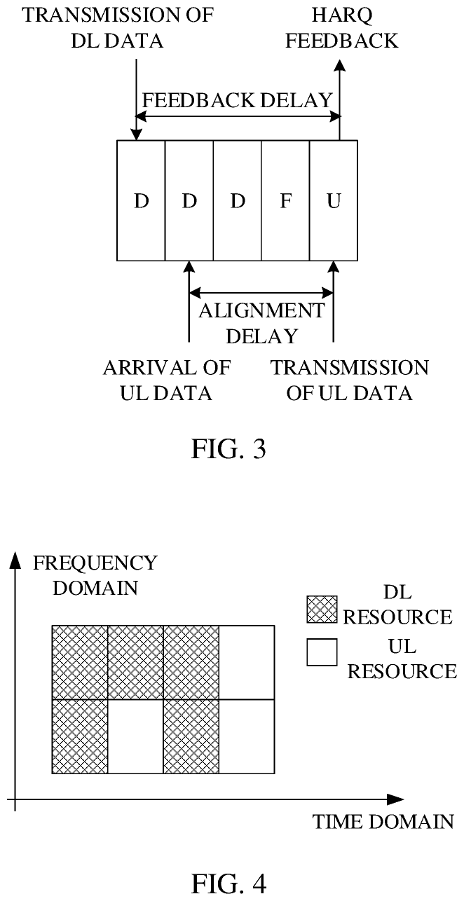

Furthermore, due to an asymmetry of services in the system, a proportion of DL services is generally larger than that of UL services, and thus DL slots and/or DL symbols often occupy a relatively large amount of resources in the slot structure configured or indicated by flexible TDD UL-DL related configuration or indication, such as a slot format similar to DDDSU, which may lead to the following.
1. Limited UL coverage due to relatively few UL resources.
2. Due to relatively few UL resources, UL data or feedback information for DL data cannot be sent until there is a UL slot and/or a UL symbol, which increases delay of UL feedback and/or UL scheduling. For example, as illustrated in FIG. 3, in the case where UL hybrid automatic repeat reQuest-acknowledge (HARQ-ACK) for DL data needs to be fed back, feedback delay between a DL symbol for transmission of the DL data and a UL symbol for feedback of the UL HARQ-ACK is too large. In the case where UL data needs to be scheduled, alignment delay between a symbol where the UL data arrives and a UL symbol for transmission of the UL data is too large.
3. Relatively low spectrum utilization efficiency due to segmentation of UL and DL time. For example, for all frequency-domain resources in a DL symbol, even if DL data does not occupy all the frequency-domain resources in the symbol, the remaining frequency-domain resources cannot be used for transmission of UL data or transmission of feedback information for the DL data.

The disclosure can overcome the above problems by means of a full-duplex communication mode, where a core concept of full-duplex communication is to perform transmission and reception at the same time. The full-duplex communication mode may include different operation modes such as a communication mode where a base station is operating in full duplex and a terminal device is operating in half duplex, a communication mode where a base station is operating in full duplex and a terminal device is operating in full duplex, etc., and relevant contents of the full-duplex communication are explained below in conjunction with the accompanying drawings.

FIGS. 4 to 6 illustrate examples of full-duplex communication-based resource formats provided in embodiments of the disclosure.

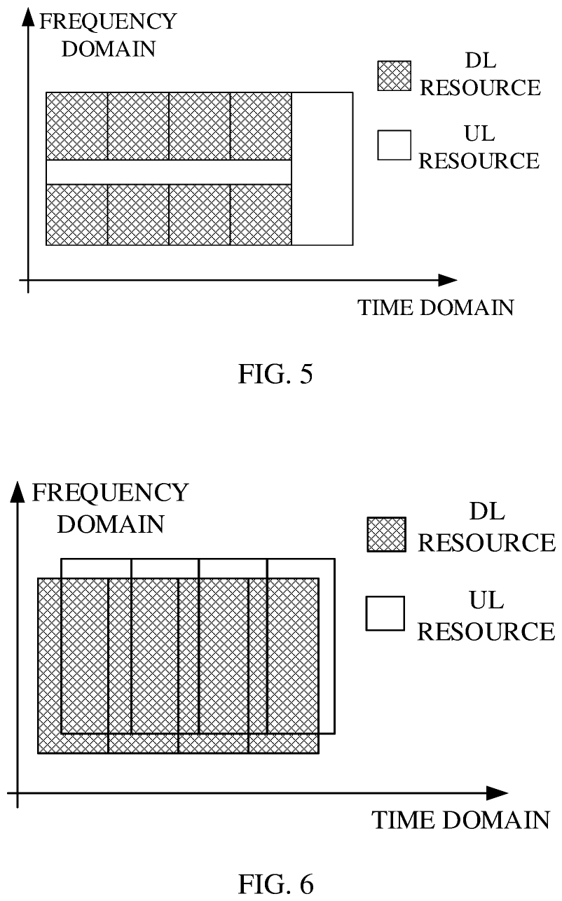

As illustrated in FIG. 4, assuming that a time-domain resource in a block represents 1 slot, a full-duplex communication-based resource format includes 4 slots, and the second slot in a direction from left to right includes both a UL resource and a DL resource, i.e., the network device can simultaneously perform transmission and reception in the second slot and the terminal device can simultaneously perform transmission and reception in the second slot. As illustrated in FIG. 5, assuming that a time-domain resource in a block represents 1 slot, a full-duplex communication-based resource format includes 5 slots, and first 4 slots in the direction from left to right each include both a UL resource and DL resources, i.e., the network device can simultaneously perform transmission and reception in the first 4 slots and the terminal device can simultaneously perform transmission and reception in the first 4 slots. As illustrated in FIG. 6, a full-duplex communication-based resource format includes UL resources and DL resources, the network device can simultaneously perform transmission and reception on time-domain resources where the UL resources and the DL resources overlap, and the terminal device can simultaneously perform transmission and reception on the time-domain resources where the UL resources and the DL resources overlap.

In actual communication procedures, the terminal device needs to receive many DL reference signals (RSs) and/or DL physical channels, for example, a synchronization signal/physical broadcast channel (SS/PBCH) block (SSB), a control resource set (CORESET), a channel state information-reference signal (CSI-RS), and a cell reference signal (CRS), to assist the terminal device in processes such as synchronization, reception of control information, and channel measurement.

In addition, the terminal device also needs to transmit many UL RSs or UL physical channels, such as a sounding reference signal (SRS), and a physical uplink control channel (PUCCH) that carries a scheduling request (SR), HARQ-ACK, and CSI, to assist the network device in performing scheduling and other operations on the terminal device.

The above type of signals and/or channels play a very important role in the system and are usually sent periodically within a period configured by higher-layer signaling or predefined by the specification.

However, in the case where a UL scheduling grant or a DL scheduling grant for data is performed via downlink control information (DCI), generally, only a whole block of time-frequency resources may be allocated to save DCI overhead. Meanwhile, in the case where the base station or the terminal device is in the full-duplex communication mode and the above type of signals and/or channels are simultaneously received on the resources allocated via the DCI, data sent may interfere with reception of the type of signals or information, which in turn reduces a system performance.

For example, taking an RS for DL measurement or DL synchronization as an example, in the case where terminal device 1 receives the RS for DL measurement or DL synchronization on a time-domain resource and terminal device 2 transmits a physical uplink shared channel (PUSCH)/PUCCH/SRS on the time-domain resource at the same time, the RS received by terminal device 1 may be subject to interference of the PUSCH/PUCCH/SRS sent by terminal device 2, which may lead to inaccurate DL measurement or failure of DL synchronization and thus reduces a system performance. Furthermore, for example, taking DCI as an example, in the case where terminal device 1 receives DCI on a time-domain resource and terminal device 2 transmits a PUSCH/PUCCH/SRS on the time-domain resource at the same time, the DCI received by terminal device 1 may be subject to interference of the PUSCH/PUCCH/SRS sent by terminal device 2, which may result in failure of reception of the DCI and thus reduces a system performance.

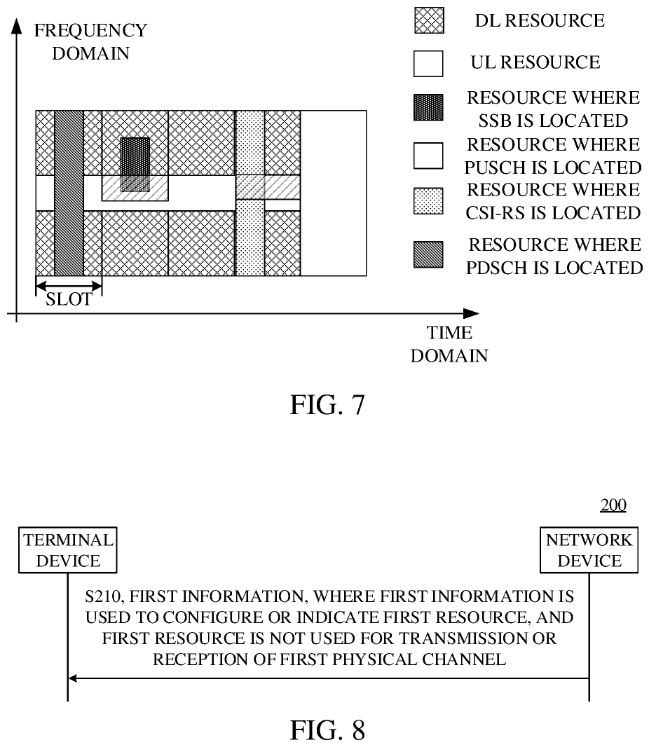

FIG. 7 illustrates another example of a full-duplex communication-based resource format provided in embodiments of the disclosure.

As illustrated in FIG. 7, assuming that the network device adopts a full-duplex communication-based resource format, a transmission location of an SSB and/or a CSI-RS is usually not changed due to the need to ensure backward compatibility of the system. Moreover, since overhead of signaling, e.g., DCI, may be increased if a PUSCH supports allocation of discrete resources, the PUSCH only supports allocation of consecutive resources. Based on this, a resource where the SSB is located and/or a resource where the CSI-RS is located may conflict with a time-frequency resource allocated for the PUSCH by the network device, which in turn causes interference generated by the PUSCH to DL reception of the SSB and/or the CSI-RS, and thus a system performance is reduced. For example, in conjunction with FIG. 7, in the case where resources in first four slots are allocated, both the resource where the SSB is located and the resource where the CSI-RS is located are in conflict with the time-frequency resource allocated for the PUSCH by the network device, which results in interference generated by the PUSCH to DL reception of the SSB and/or the CSI-RS, and thus a system performance is reduced.

Meanwhile, due to an asymmetry of services in the system, a proportion of DL services is generally larger than that of UL services, which means that resources occupied by the DL services are generally more than those occupied by the UL services. In this case, it is very likely to lead to a conflict between the resources where the DL services are located and a PUCCH to-be-sent (e.g., an SR, HARQ-ACK, or a CSI report), which may in turn reduce a system performance. In conjunction with FIG. 7, in the case where a configured PUCCH (e.g., an SR, HARQ-ACK, or a CSI report) is to be sent on a UL resource in the first slot, and a physical downlink shared channel (PDSCH) illustrated in FIG. 7 is a big packet service, the PDSCH needs to occupy an entire bandwidth or even an entire resource in the first slot. In this case, it is very likely to result in a conflict between a resource where the PDSCH is located and the PUCCH to-be-sent (e.g., the SR, the HARQ-ACK, or the CSI report), which may reduce a system performance.

Based on this, a method for wireless communication, a terminal device, and a network device are provided in embodiments of the disclosure, which can reduce interference that is generated by a sent physical channel to a signal or information received on a specific resource, and in turn can improve a system performance.

FIG. 8 is a schematic flow chart illustrating a method 200 for wireless communication according to embodiments of the disclosure. The method 200 may be performed interactively by a terminal device and a network device. The terminal device illustrated in FIG. 8 may be the terminal device illustrated in FIG. 1, and the network device illustrated in FIG. 8 may be the access network device illustrated in FIG. 1.

As illustrated in FIG. 8, the method 200 includes some or all of the following.

At S210, the terminal device receives first information sent by the network device, where the first information is used to configure a first resource or indicate the first resource, and the first resource is not used for transmission or reception of a first physical channel.

In other words, the network device transmits the first information to the terminal device to configure or indicate the first resource to the terminal device. Accordingly, upon reception of the first information, the terminal device may transmit or receive a signal or a channel on the first resource according to the first resource configured or indicated via the first information, and determine whether to transmit or receive the first physical channel according to the first resource configured or indicated via the first information.

In other words, the first resource is used to assist in transmission or reception of the first physical channel.

Specifically, the terminal device may transmit or receive the first physical channel according to the first information or the first resource. For example, the terminal device may transmit, according to the first information or the first resource, the first physical channel through resource mapping. That is, the terminal device maps the first physical channel onto a resource where the first physical channel is located rather than onto the first resource, and the resource where the first physical channel is located may be configured by the network device via radio resource control (RRC) signaling or indicated via physical layer control information. The terminal device may determine whether to transmit or receive the first physical channel according to the first information or the first resource. For example, in the case of no overlapping between the first resource and the first physical channel, the terminal device may transmit or receive the first physical channel on the resource where the first physical channel is located, and accordingly, the network device may receive or transmit the first physical channel on the resource where the first physical channel is located. For another example, in the case of overlapping between the first resource and the first physical channel, the terminal device may not transmit (i.e., cancel transmission of) or not receive (i.e., cancel reception of) the first physical channel, and accordingly, the network device cancels reception or transmission of the first physical channel.

In the embodiment, the first information is introduced and designed to be used to configure or indicate the first resource that is not used for transmission or reception of the first physical channel, so that it is conducive for the terminal device to determine not to transmit or receive the first physical channel through the first resource, or even conducive for the terminal device to determine whether to cancel transmission or reception of the first physical channel, which in turn can reduce interference that is generated by the first physical channel to a signal or a channel received on the first resource and thus can improve a system performance. For example, in the case where the terminal device transmits the first physical channel, it is possible to reduce interference that is generated by the first physical channel to a signal or a channel received by the terminal device on the first resource. For another example, in the case where the terminal device receives the first physical channel, it is possible to reduce interference that is generated by the first physical channel to a signal or a channel received by the network device on the first resource. That is, in the method for wireless communication provided in embodiments of the disclosure, interference that is generated by a sent physical channel to a signal or information received on a particular resource can be reduced, thereby improving a system performance.

It needs to be noted that normally, for the first physical channel, the terminal device only needs to identify the resource where the first physical channel is located, and the terminal device is not concerned with a resource not used for transmission or reception of the first physical channel, and a concept of the first information is newly introduced in the disclosure to solve the problem of interference with a signal received on the first resource.

In addition, overhead of signaling, e.g., DCI, may be increased in the case where the first physical channel supports allocation of discrete resources, and overlapping between the first physical channel and a resource that is not used for transmission or reception of the first physical channel (i.e., data) may occur in the case where the first physical channel only supports allocation of consecutive resources. However, in the disclosure, even if the first physical channel only supports allocation of consecutive resources, after the terminal device determines the first resource that is not used for transmission or reception of the first physical channel, it is conducive for the terminal device to refrain from using the first resource to transmit or receive the first physical channel, or even conducive for the terminal device to determine whether to cancel transmission or reception of the first physical channel, which in turn can reduce or even avoid interference that is generated by the first physical channel to a signal or a channel received on the first resource and thus can improve a system performance.

It needs to be noted that the first resource involved in embodiments of the disclosure is intended to indicate that the first resource is unavailable (or is unable to be used) for transmission or reception of the first physical channel. That is to say, any resource that is unavailable for transmission of the first physical channel may be assigned as the first resource. In addition, a type and a position of the first resource are not limited in the disclosure.

For example, a resource allocated for the first physical channel by the network device may include the first resource or may not include the first resource. Alternatively, the resource allocated for the first physical channel by the network device may overlap completely or partially the first resource, or may not overlap the first resource. Exemplarily, in the case where the resource allocated for the first physical channel by the network device includes the first resource or in the case where the resource allocated for the first physical channel by the network device overlaps completely or partially the first resource, it means that a signal or a channel received on the first resource may be subject to interference of the first physical channel, and in this case, the first resource is not used for transmission or reception of the first physical channel. In the case where the resource allocated for the first physical channel by the network device does not include the first resource or in the case where the resource allocated for the first physical channel by the network device does not overlap the first resource, the first physical channel may be received or sent on the resource allocated for the first physical channel by the network device, and a signal on the first resource may be sent on the first resource. That is, transmission of the first physical channel and transmission of a signal or a channel on the first resource do not affect each other.

For another example, the first resource may include a resource that is not used for transmission of a PUSCH and/or a resource that is not used for reception of a PDSCH.

For another example, the first resource is a UL resource or a DL resource. The case that the first resource is a DL resource may be understood as follows. The first resource is available for DL transmission by the network device or the first resource is unavailable for UL transmission by the terminal device. The case that the first resource is a UL resource may be understood as follows. The first resource is available for UL reception by the network device or the first resource is unavailable for DL reception by the terminal device.

It needs to be noted that the first resource may be a UL resource or a DL resource for a certain subband.

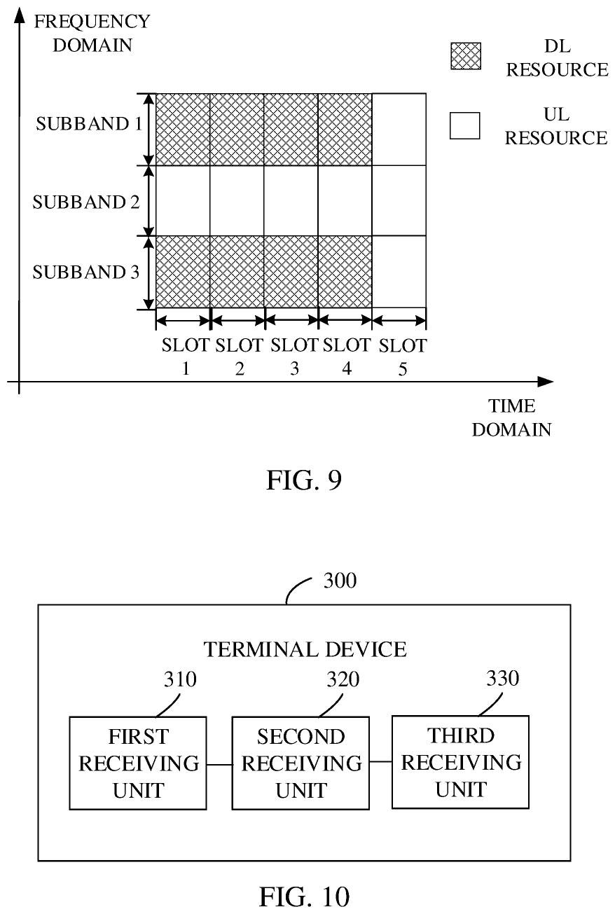

FIG. 9 illustrates an example of the first resource that is not used for transmission or reception of the first physical channel, provided in embodiments of the disclosure.

As illustrated in FIG. 9, assuming that the network device is in a full-duplex communication mode and the terminal device is in a half-duplex communication mode, from the perspective of the system, subband 1 and subband 3 in each of slots 1 to 4 are DL resources, and subband 2 in each of slots 1 to 4 is a UL resource. The terminal device can only perform reception or transmission at a time due to the half-duplex communication mode. That is to say, from the perspective of the terminal device, resources in slots 1 to 4 are UL resources or resources in slots 1 to 4 are DL resources. For example, for terminal device 1, it may be UL resources and terminal device 1 is scheduled to transmit a PUSCH and/or a PUCCH in subband 2, and for terminal device 2, it may be DL resources and terminal device 2 is scheduled to receive in subband 1 and/or subband 3 DL information such as a PDSCH. However, regardless of terminal device 1 or terminal device 2, it is impossible to perform transmission in subband 1 and/or subband 3 or reception in subband 2.

In conjunction with the first resource, in the case where the first resource is a DL resource, the first resource is a resource in subband 1 and subband 3 in each of slots 1 to 4, and in the case where the first resource is a UL resource, the first resource is a resource in subband 2 in each of slots 1 to 4.

It may be understood that in other alternative embodiments, the subband involved in the disclosure may be replaced with a band or a frequency point, which is not specifically limited in the disclosure.

It further needs to be noted that the term “indication” referred to in the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation. In connection with the disclosure, A denotes the first information and B denotes the first resource. Furthermore, the term “indication” may be implemented as an indication via physical-layer control information. Similarly, the term “configuration” referred to in the disclosure may be configured via higher-layer signaling, where the higher-layer signaling includes, but is not limited to, a system information block (SIB), RRC, and medium access control (MAC).

In some embodiments, the first resource is not used for transmission or reception of the first physical channel as follows. The terminal device does not expect overlapping between the first physical channel and the first resource, or the terminal device does not expect to transmit or receive the first physical channel in the case of overlapping between the first physical channel and the first resource.

It needs to be noted that in the disclosure, overlapping between the first physical channel and the first resource may be understood as follows. The resource where the first physical channel is located overlaps partially or completely the first resource, or the resource allocated for the first physical channel by the network device overlaps partially or completely the first resource. The case that the terminal device does not expect to transmit or receive the first physical channel may be understood as follows. The terminal device is not required to transmit or receive the first physical channel. In the case where the terminal device does not expect to transmit the first physical channel, accordingly, the network device may or may not attempt to receive the first physical channel. In the case where the terminal device does not expect to transmit the first physical channel, accordingly, the network device may or may not attempt to receive the first physical channel. The case that the terminal device does not expect to transmit or receive the first physical channel may include the following. The terminal device does not expect to transmit or receive the first physical channel on the resource where the first physical channel is located, or the terminal device does not expect to transmit or receive the first physical channel on the first resource.

In some embodiments, the first physical channel is a PUSCH.

Optionally, the first resource includes at least one of a resource where an SSB is located, a CORESET, a resource where a CSI-RS is located, or a resource where a CRS is located.

In the embodiment, for the terminal device, the first resource is designed to include at least one of the resource where the SSB is located, the CORESET, the resource where the CSI-RS is located, or the resource where the CRS is located, which can reduce interference generated by the first physical channel to reception of the SSB, reception of a channel carried in the CORESET, reception of the CSI-RS, or reception of the CRS. Specifically, reduction in interference with reception of the SSB can improve a DL synchronization performance, reduction in interference with reception of the channel carried in the CORESET can improve reliability of a PDCCH, reduction in interference with reception of the CSI-RS can improve accuracy of a CSI report, and reduction in interference with reception of the CRS can effectively ensure coexistence between the NR and the LTE. Meanwhile, for the network device, it is possible to reduce interference generated by the SSB, the channel carried in the CORESET, the CSI-RS, or the CRS to reception of the first physical channel.

In some embodiments, the first physical channel is a PDSCH.

Optionally, the first resource includes at least one of: a resource where a first PUCCH is located, or an SRS resource.

In the embodiment, for the network device, the first resource is designed to include at least one of the resource where the first PUCCH is located or the SRS resource, which can reduce interference generated by the first physical channel to reception of the first PUCCH or reception of the SRS. Meanwhile, for the terminal device, it is possible to reduce interference generated by the first PUCCH or the SRS to reception of the first physical channel.

Optionally, the resource where the first PUCCH is located includes at least one of: a resource where an SR is located, a resource where HARQ-ACK is located, or a resource where CSI is located.

In some embodiments, the case that the first resource is not used for transmission or reception of the first physical channel includes that: the case that the first resource is not used for transmission or reception of the first physical channel is predefined by a protocol.

In other words, it may be agreed via protocol predefinition that the first resource indicated or configured via the first information is not used for transmission or reception of the first physical channel.

Exemplarily, it may be agreed via protocol predefinition that a resource(s) where at least one first signal indicated or configured via the first information is located is not used for transmission or reception of the first physical channel. For another example, it may be agreed via protocol predefinition that a resource(s) where at least one first channel indicated or configured via the first information is located is not used for transmission or reception of the first physical channel. That is, as long as the terminal device determines the resource(s) where the at least one first signal is located and/or the resource(s) where the at least one first channel is located, the terminal device may directly determine the resource(s) where the at least one first signal is located and/or the resource(s) where the at least one first channel is located as the first resource that is not used for transmission or reception of the first physical channel. Optionally, in the case where the first physical channel is a PUSCH, the at least one first signal includes at least one of a CSI-RS or a CRS; and/or, the at least one first channel includes at least one of an SSB, or a channel carried in a CORESET. Optionally, in the case where the first physical channel is a PDSCH, the at least one first signal includes an SRS; and/or, the at least one first channel includes a second PUCCH. Optionally, information carried in the second PUCCH includes at least one of an SR, HARQ-ACK, or CSI.

It needs to be noted that, in embodiments of the disclosure, “protocol predefinition” may be implemented by pre-storing corresponding codes, tables, or other modes indicating relevant information in a device (for example, including a terminal device and a network device), and specific embodiments are not limited in the disclosure. For example, protocol predefinition may refer to definition in a standard protocol in the field of communications, and a type of the standard protocol is not limited in the disclosure. For example, the standard protocol may include an LTE protocol, an NR protocol, and a related protocol applicable to a future communication system, which is not specifically limited in the disclosure.

In some embodiments, the first resource includes a resource(s) indicated by at least one first rate-matching pattern.

Exemplarily, in the case where a value of a first bit in the first rate-matching pattern is a first value, a resource corresponding to the first bit belongs to the resource indicated by the first rate-matching pattern, i.e., the resource corresponding to the first bit belongs to the first resource. In the case where the value of the first bit is a second value, the resource corresponding to the first bit does not belong to the resource indicated by the first rate-matching pattern, i.e., the resource corresponding to the first bit does not belong to the first resource. Optionally, the first value is 0 and the second value is 1. Alternatively, the first value is 1 and the second value is 0.

In other alternative embodiments, the at least one first rate-matching pattern may be referred to as at least one bitmap.

Optionally, the first information is used to configure the at least one first rate-matching pattern.

In other words, the at least one first rate-matching pattern is configured via the first information, or the first information contains the at least one first rate-matching pattern. Accordingly, the terminal device may determine the resource(s) indicated by the at least one first rate-matching pattern as the first resource.

In the embodiment, the at least one first rate-matching pattern is directly configured via the first information and the resource indicated by the at least one first rate-matching pattern is directly assigned as the first resource, so that the network device can flexibly indicate to the terminal device the first resource that is unavailable for the first physical channel, thereby improving a system performance.

Exemplarily, the first information contains at least one first field, where the at least one first field is used to carry the at least one first rate-matching pattern.

Optionally, the first information indicates an index(es) of the at least one first rate-matching pattern.

In other words, the index of the at least one first rate-matching pattern is indicated via the first information. Accordingly, the terminal device may determine the resource indicated by the at least one first rate-matching pattern as the first resource.

In the embodiment, the index(es) of the at least one first rate-matching pattern is directly indicated via the first information and the resource(s) indicated by the at least one first rate-matching pattern is directly assigned as the first resource, so that not only can the network device flexibly indicate to the terminal device the first resource that is unavailable for the first physical channel, thereby improving a system performance, but also the number of bits occupied by the first information can be reduced, thereby saving communication resources.

Exemplarily, the first information contains a second field, where a value of the second field indicates the index of the at least one first rate-matching pattern. That is, different values of the second field indicate at least one different first rate-matching pattern, or indicate the at least one first rate-matching pattern with different indexes.

It may be understood that the index(es) of the at least one first rate-matching pattern involved in the disclosure may be one index or include multiple indexes, which is not limited in the disclosure. For example, the index(es) of the at least one first rate-matching pattern may be a single index, which is equal to that a combination formed by the at least one first rate-matching pattern is uniquely identified via the single index. For another example, the index of the at least one first rate-matching pattern may include an index of each first rate-matching pattern.

Optionally, the method 200 may further include receiving first configuratioinformation. The first configuration information is used to configure at least one second ratematching pattern, and the at least one second rate-matching pattern includes the at least one first rate-matching pattern.

In some embodiments, the resource(s) indicated by the at least one first rate-matching pattern includes the resource(s) where the at least one first signal is located and/or the resource(s) where the at least one first channel is located. Optionally, in the case where the first physical channel is a PUSCH, the at least one first signal includes at least one of a CSI-RS or a CRS; and/or, the at least one first channel includes at least one of an SSB, or a channel carried in a CORESET. Optionally, in the case where the first physical channel is a PDSCH, the at least one first signal includes an SRS; and/or, the at least one first channel includes a second PUCCH. Optionally, information carried in the second PUCCH includes at least one of an SR, HARQ-ACK, or CSI.

In some embodiments, the first resource includes the resource(s) where the at least one first signal is located and/or the resource(s) where the at least one first channel is located. Optionally, in the case where the first physical channel is a PUSCH, the at least one first signal includes at least one of a CSI-RS or a CRS; and/or, the at least one first channel includes at least one of an SSB, or a channel carried in a CORESET. Optionally, in the case where the first physical channel is a PDSCH, the at least one first signal includes an SRS; and/or, the at least one first channel includes a second PUCCH. Optionally, information carried in the second PUCCH includes at least one of an SR, HARQ-ACK, or CSI.

Optionally, the first information is used to configure the resource(s) where the at least one first signal is located and/or the resource(s) where the at least one first channel is located.

In other words, the resource(s) where the at least one first signal is located and/or the resource(s) where the at least one first channel is located is configured via the first information. Accordingly, the terminal device may determine the resource(s) where the at least one first signal is located and/or the resource(s) where the at least one first channel is located as the first resource.

Exemplarily, the first information contains at least one third field and/or at least one fourth field. The at least one third field is used to carry an indication indicative of the resource where the at least one first signal is located, and the at least one fourth field is used to carry an indication indicative of the resource where the at least one first channel is located.

Optionally, the first information indicates an index(es) of the at least one first signal and/or an index(es) of the at least one first channel.

In other words, the index(es) of the at least one first signal and/or the index(es) of the at least one first channel is indicated via the first information. Accordingly, the terminal device may determine the resource(s) where the at least one first signal is located and/or the resource(s) where the at least one first channel is located as the first resource.

Exemplarily, the first information contains a fifth field and/or a sixth field. A value of the fifth field indicates the index of the at least one first signal. That is to say, different values of the fifth field indicate indexes of at least one different first signal or indicate the at least one first signal with different indexes. A value of the sixth field indicates the at least one first channel. That is to say, different values of the sixth field indicate at least one different first channel or indicate the at least one first channel with different indexes.

Optionally, the method 200 may further include receiving second configuration information. The second configuration information is used to configure a resource(s) for at least one second signal and/or configure a resource(s) for at least one second channel, the at least one second signal includes the at least one first signal, and the at least one second channel includes the at least one first channel. Optionally, the first signal is the same as or different from the second signal in type, and the first channel is the same as or different from the second channel in type.

In some embodiments, the first information is carried in RRC signaling or DCI.

It needs to be noted that specific implementation manners for carrying the first information in the RRC signaling or the DCI are not limited in the disclosure. For example, the first information is carried in a field in the RRC signaling or the DCI, where the field may be a reserved field or a field specifically set up for the first information.

In some embodiments, the terminal device does not expect overlapping between a demodulation reference signal (DMRS) for the first physical channel and the first resource, or the terminal device does not expect to transmit or receive the DMRS for the first physical channel in the case of overlapping between the DMRS for the first physical channel and the first resource.

It needs to be noted that in the disclosure, overlapping between the DMRS for the first physical channel and the first resource may be understood as follows. A resource where the DMRS for the first physical channel is located overlaps partially or completely the first resource, or a resource allocated by the network device for the DMRS for the first physical channel overlaps partially or completely the first resource. Optionally, the terminal device does not expect to transmit or receive the DMRS for the first physical channel as follows. The terminal device does not expect to transmit or receive the DMRS for the first physical channel on the resource where the first physical channel is located, or the terminal device does not expect to transmit or receive the DMRS for the first physical channel on the first resource.

In some embodiments, the first resource is a resource(s) in a first time-domain range, and/or, the first resource is a resource(s) in a first frequency-domain range.

In other words, the first resource is unavailable for the first physical channel in the first time-domain range; or the first resource is unavailable for the first physical channel in the first frequency-domain range; or the first resource is unavailable for the first physical channel in the first frequency-domain range in the first time-domain range; or the first resource is unavailable for the first physical channel in the first time-domain range in the first frequency-domain range.

It may be understood that in other alternative embodiments, the first time-domain range may be replaced with a set of first time-domain resource units or at least one time-domain resource unit. The time-domain resource unit includes, but is not limited to, a slot, a symbol, a sub-slot, a frame, a sub-frame, and the like. Similarly, the first frequency-domain range may be replaced with a set of first frequency-domain resource units or at least one frequency-domain resource unit. The frequency-domain resource unit includes, but is not limited to, a band, a subband, a frequency point, a resource block (RB), an RB group, a resource element (RE), an RE group, and the like.

Optionally, the first time-domain range is indicated or configured by the network device, or the first time-domain range is predefined by a protocol.

Optionally, the first frequency-domain range is indicated or configured by the network device, or the first frequency-domain range is predefined by the protocol.

It needs to be noted that a manner for indicating or configuring the first time-domain range and the first frequency-domain range is not specifically limited in the disclosure.

For example, the network device may configure or indicate the first frequency-domain range in the first time-domain range. For another example, the network device may indicate the first time-domain range in the first frequency-domain range.

For another example, the first time-domain range or the first frequency-domain range may be indicated or configured via a bitmap. For example, the first time-domain range may be indicated or configured via a second bitmap, where the case that a value of a second bit in the second bitmap is a first value indicates that a resource corresponding to the second bit belongs to the first time-domain range, and the case that the value of the second bit is a second value indicates that the resource corresponding to the second bit does not belong to the first time-domain range. For another example, the first frequency-domain range may be indicated or configured via a third bitmap, where the case that a value of a third bit in the third bitmap is the first value indicates that a resource corresponding to the third bit belongs to the first frequency-domain range, and the case that the value of the third bit is the second value indicates that the resource corresponding to the third bit does not belong to the first frequency-domain range. Optionally, the first value is 0 and the second value is 1. Alternatively, the first value is 1 and the second value is 0. The network device may directly indicate both the first time-domain range and the first frequency-domain range via a two-dimensional (2D) bitmap, instead of first indicating the first time-domain range and then indicating the first frequency-domain range, or first indicating the first frequency-domain range and then indicating the first time-domain range, which is not specifically limited in the disclosure.

It further needs to be noted that the term “indication” referred to in the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation. In connection with the disclosure, B denotes a first time-domain resource or a first frequency-domain resource. Furthermore, the term “indication” may be implemented as an indication via physical-layer control information. Similarly, the term “configuration” referred to in the disclosure may be configured via higher-layer signaling, where the higher-layer signaling includes, but is not limited to, an SIB, RRC, and MAC.

In some embodiments, the method is applicable to full-duplex communication.

For example, the method is applicable to full-duplex communication by the terminal and/or full-duplex communication by the network device.

The following describes the solutions in the disclosure in conjunction with specific embodiments.

### Embodiment 1

In the embodiment, the terminal device receives the first information sent by the network device. The first information is used to configure or indicate the first resource, and the first resource is not used for transmission of a first PUSCH. Specifically, the first information may configure or indicate the first resource in the following manners.

### Manner 1

The terminal device receives the first information sent by the network device. The first resource includes the resource(s) indicated by the at least one first rate-matching pattern. Specifically, the first information is used to configure the at least one first rate-matching pattern, or the first information indicates the index(es) of the at least one first rate-matching pattern.

Specifically, the network device configures the at least one first rate-matching pattern for the terminal device via higher-layer signaling, where the at least one first rate-matching pattern indicates a series of time-frequency resources, and the series of time-frequency resources are unavailable for the first PUSCH. That is to say, the resource(s) indicated by the at least one first rate-matching pattern is unavailable for transmission of the first PUSCH. For example, the at least one first rate-matching pattern may indicate a CORESET resource, a reserved resource, and the like. The network device may configure the at least one second rate-matching pattern for the terminal device via higher-layer signaling, and then indicate to the terminal device the at least one first rate-matching pattern in the at least one second rate-matching pattern via DCI. The resource(s) indicated by the at least one first rate-matching pattern is unavailable for transmission of the first PUSCH.

### Manner 2

The terminal device receives the first information sent by the network device. The first resource includes the resource where the at least one first signal is located and/or the resource(s) where the at least one first channel is located. The first information is used to configure the resource(s) where the at least one first signal is located and/or the resource(s) where the at least one first channel is located, or the first information indicates the index(es) of the at least one first signal and/or the index(es) of the at least one first channel.

Take that the at least one first signal includes a CSI-RS as an example, i.e., a resource where the CSI-RS is located is unavailable for the first PUSCH. The network device configures at least one CSI-RS resource for the terminal device via higher-layer signaling, where the at least one CSI-RS resource is unavailable for transmission of the first PUSCH, and the at least one CSI-RS resource is periodic, aperiodic, or semi-persistent. It is possible to configure multiple CSI-RS resources via higher-layer signaling, and then to indicate to the terminal device at least one CSI-RS resource in the multiple CSI-RS resources via DCI. The at least one CSI-RS resource is unavailable for transmission of the first PUSCH.

In other alternative embodiments, the CSI-RS may be replaced with a CRS, an SS/PBCH, a channel carried in a CORESET, etc., which is not specifically limited in the disclosure.

In the embodiment, a resource(s) where the first PUSCH is located is a UL resource and the first resource is a DL resource. The UL resource and the DL resource involved in the disclosure may be a resource in the first frequency-domain range and/or a resource in the first time-domain range. For example, in conjunction with FIG. 9, the UL resource may be a resource in slots 1 to 4 and/or a resource in subbands 2, and for another example, the DL resource may be a resource in slots 1 to 4 and/or a resource in subbands 1 and subbands 3. It may be noted that in the embodiment the slot is an example of a time-domain resource unit in the first time-domain range and the suband is an example of a frequency-domain resource unit in the first frequency-domain range, and the slot and the subband in other alternative embodiments may be respectively replaced with resource units at other granularities, which are not specifically limited in the disclosure. Furthermore, the first time-domain range and/or the first frequency-domain range may be predefined by a protocol, configured by the network device via higher-layer signaling, or indicated via DCI, which is not specifically limited in the disclosure.

Notably, the first resource is not used for transmission of the first PUSCH as follows. The terminal device does not expect overlapping between the first PUSCH and the first resource, or the terminal device does not expect to transmit the first PUSCH in the case of overlapping between the first PUSCH and the first resource. Overlapping between the first PUSCH and the first resource may be understood as follows. The resource where the first PUSCH is located overlaps partially or completely the first resource, or a resource allocated for the first PUSCH by the network device overlaps partially or completely the first resource. The case that the terminal device does not expect to transmit the first PUSCH may be understood as follows. The terminal device is not required to transmit the first PUSCH. The case that the terminal device does not expect to transmit the first PUSCH may include the following. The terminal device does not expect to transmit the first PUSCH on the resource where the first PUSCH is located, or the terminal device does not expect to transmit the first PUSCH on the first resource.

### Embodiment 2

In the embodiment, the terminal device receives the first information sent by the network device. The first information is used to configure or indicate the first resource, and the first resource is not used for reception of a first PDSCH. Specifically, the first information may configure or indicate the first resource in the following manners.

### Manner 1

The terminal device receives the first information sent by the network device. The first resource includes the resource(s) indicated by the at least one first rate-matching pattern. Specifically, the first information is used to configure the at least one first rate-matching pattern, or the first information indicates the index(es) of the at least one first rate-matching pattern.

Specifically, the network device configures the at least one first rate-matching pattern for the terminal device via higher-layer signaling, where the at least one first rate-matching pattern indicates a series of time-frequency resources, and the series of time-frequency resources are unavailable for the first PDSCH. That is to say, the resource(s) indicated by the at least one first rate-matching pattern is unavailable for transmission of the first PDSCH. For example, the at least one first rate-matching pattern may indicate a resource(s) where a PUCCH is located, such as a resource where an SR is located, a resource where HARQ-ACK is located, a resource where CSI is located, and so on. The network device may configure the at least one second rate-matching pattern for the terminal device via higher-layer signaling, and then indicate to the terminal device the at least one first rate-matching pattern in the at least one second rate-matching pattern via DCI. The resource indicated by the at least one first rate-matching pattern is unavailable for transmission of the first PDSCH.

### Manner 2

The terminal device receives the first information sent by the network device. The first resource includes the resource(s) where the at least one first signal is located and/or the resource(s) where the at least one first channel is located. The first information is used to configure the resource(s) where the at least one first signal is located and/or the resource(s) where the at least one first channel is located, or the first information indicates the index(es) of the at least one first signal and/or the index(es) of the at least one first channel.

Take that the at least one first signal includes an SRS as an example, i.e., a resource where the SRS is located is unavailable for the first PUSCH. The network device configures at least one SRS resource for the terminal device via higher-layer signaling, where the at least one SRS resource is unavailable for transmission of the first PDSCH, and the at least one SRS resource is periodic, aperiodic, or semi-persistent. It is possible to configure multiple SRS resources via higher-layer signaling, and then to indicate to the terminal device at least one SRS resource in the multiple SRS resources via DCI. The at least one SRS resource is unavailable for transmission of the first PDSCH.

In other alternative embodiments, the SRS may also be replaced with a channel for carrying an SR, HARQ-ACK, CSI, and the like, which is not specifically limited in the disclosure. Exemplarily, a resource where the CSI is located may be periodic, aperiodic, or semi-persistently scheduled, a resource where the SR is located may be periodic, and a resource where the HARQ-ACK is located may be periodic or indicated via DCI.

In the embodiment, a resource where the first PDSCH is located is a DL resource and the first resource is a UL resource. The UL resource and the DL resource involved in the disclosure may be a resource in the first frequency-domain range and/or a resource in the first time-domain range. For example, in conjunction with FIG. 9, the UL resource may be a resource in slots 1 to 4 and/or a resource in subbands 2, and for another example, the DL resource may be a resource in slots 1 to 4 and/or a resource in subbands 1 and subbands 3. It may be noted that in the embodiment the slot is an example of a time-domain resource unit in the first time-domain range and the subband is an example of a frequency-domain resource unit in the first frequency-domain range, and the slot and the subband in other alternative embodiments may be respectively replaced with resource units at other granularities, which are not specifically limited in the disclosure. Furthermore, the first time-domain range and/or the first frequency-domain range may be predefined by a protocol, configured by the network device via higher-layer signaling, or indicated via DCI, which is not specifically limited in the disclosure.

Notably, the first resource is not used for reception of the first PDSCH as follows. The terminal device does not expect overlapping between the first PDSCH and the first resource, or the terminal device does not expect to receive the first PDSCH in the case of overlapping between the first PDSCH and the first resource. Overlapping between the first PDSCH and the first resource may be understood as follows. The resource where the first PDSCH is located overlaps partially or completely the first resource, or a resource allocated for the first PDSCH by the network device overlaps partially or completely the first resource. The case that the terminal device does not expect to receive the first PDSCH may be understood as follows. The terminal device is not required to receive the first PDSCH. The case that the terminal device does not expect to receive the first PDSCH may include the following. The terminal device does not expect to receive the first PDSCH on the resource where the first PDSCH is located, or the terminal device does not expect to receive the first PDSCH on the first resource.

### Embodiment 3

In the embodiment, a resource where a CSI-RS is located may be defined in a frequency domain as a DL physical resource block (PRB) in a set of frequency-domain resource units for obtaining CSI. Optionally, the DL PRB does not include a frequency-domain resource unit in the set of frequency-domain resource units, where the frequency-domain resource unit is indicated or configured as UL and/or flexible by the network device. For example, in conjunction with FIG. 9, the DL PRB does not include a resource in subband 2 in the frequency domain.

In the embodiment, not only can resource utilization be improved, but also the terminal device may be subject to less interference of UL transmissions by other terminal devices in the case where the terminal device performs measurement on a CSI-RS.

Exemplary embodiments of the disclosure have been described in detail above in connection with the accompanying drawings. However, the disclosure is not limited to the details of the above embodiments. Various simple modifications can be made to the technical solution of the disclosure within the scope of the technical concept of the disclosure, and such simple modifications shall be within the protection scope of the disclosure. For example, it is to be noted that, all the technical features described in the above embodiments can be combined with each other in any proper manner without conflict. In order to avoid unnecessary repetition, various manners of combination will not be elaborated in the disclosure. For another example, various embodiments of the disclosure can also be randomly combined without departing from the spirit of the disclosure, and such combination should also be regarded as content disclosed by the disclosure.

It may further be understood that, in various embodiments described herein, the magnitude of a sequence number of each process does not mean an order of execution, and the order of execution of each process should be determined by its function and an internal logic and shall not constitute any limitation to an implementation process of embodiments. Furthermore, in embodiments of the disclosure, the terms “DL” and “UL” indicate a transmission direction of a signal or data, where “DL” indicates that the transmission direction of the signal or data is a first direction from a site to a UE in a cell, and “UL” indicates that the transmission direction of the signal or data is a second direction from the UE in the cell to the site. For example, “DL signal” indicates that a transmission direction of the signal is the first direction. In addition, the term “and/or” in embodiments of the disclosure is simply an illustration of an association relationship of associated objects, indicating that three relationships can exist, specifically, A and/or B, which can indicate the existence of A alone, A and B together, and B alone. In addition, the character “/” in this disclosure generally indicates that associated objects are in an “or” relationship.

The above describes in detail method embodiments of the disclosure in conjunction with FIGS. 1 to 9, and the following describes in detail apparatus embodiments of the disclosure in conjunction with FIGS. 10 to 13.

FIG. 10 is a schematic block diagram illustrating a terminal device 300 in embodiments of the disclosure.

As illustrated in FIG. 10, the terminal device 300 includes a first receiving unit 310. The first receiving unit 310 is configured to receive first information. The first information is used to configure or indicate a first resource, and the first resource is not used for transmission or reception of a first physical channel.

In some embodiments, the first resource is not used for transmission or reception of the first physical channel as follows. The terminal device does not expect overlapping between the first physical channel and the first resource, or the terminal device does not expect to transmit or receive the first physical channel in the case of overlapping between the first physical channel and the first resource.

In some embodiments, the case that the first resource is not used for transmission or reception of the first physical channel includes that: the case that the first resource is not used for transmission or reception of the first physical channel is predefined by a protocol.

In some embodiments, the first physical channel is a PUSCH.

In some embodiments, the first resource includes at least one of a resource where an SSB is located, a CORESET, a resource where a CSI-RS is located, or a resource where a CRS is located.

In some embodiments, the first physical channel is a PDSCH.

In some embodiments, the first resource includes at least one of a resource where a first PUCCH is located, or an SRS resource.

In some embodiments, the resource where the first PUCCH is located includes at least one of a resource where an SR is located, a resource where HARQ-ACK is located, or a resource where CSI is located.

In some embodiments, the first resource includes a resource(s) indicated by at least one first rate-matching pattern.

In some embodiments, the first information is used to configure the at least one first rate-matching pattern.

In some embodiments, the first information indicates an index(es) of the at least one first rate-matching pattern.

In some embodiments, the terminal device 300 may further include a second receiving unit 320. The second receiving unit 320 is configured to receive first configuration information. The first configuration information is used to configure at least one second rate-matching pattern, and the at least one second rate-matching pattern includes the at least one first rate-matching pattern.

In some embodiments, the resource indicated by the at least one first rate-matching pattern includes a resource(s) where at least one first signal is located and/or a resource(s) where at least one first channel is located.

In some embodiments, the first resource includes the resource(s) where the at least one first signal is located and/or the resource(s) where the at least one first channel is located.

In some embodiments, the first information is used to configure the resource(s) where the at least one first signal is located and/or the resource(s) where the at least one first channel is located.

In some embodiments, the first information indicates an index(es) of the at least one first signal and/or an index(es) of the at least one first channel.

In some embodiments, the terminal device 300 may further include a third receiving unit 330. The third receiving unit 330 is configured to receive second configuration information. The second configuration information is used to configure a resource(s) for at least one second signal and/or configure a resource(s) for at least one second channel, the at least one second signal includes the at least one first signal, and the at least one second channel includes the at least one first channel.

In some embodiments, the first physical channel is a PUSCH, where the at least one first signal includes at least one of a CSI-RS or a CRS; and/or the at least one first channel includes at least one of an SSB/PBCH, or a channel carried in a CORESET.

In some embodiments, the first physical channel is a PDSCH, where the at least one first signal includes an SRS; and/or, the at least one first channel includes a second PUCCH.

In some embodiments, information carried in the second PUCCH includes at least one of an SR, HARQ-ACK, or CSI.

In some embodiments, the first information is carried in RRC signaling or DCI.

In some embodiments, the terminal device does not expect overlapping between a DMRS for the first physical channel and the first resource, or the terminal device does not expect to transmit or receive the DMRS for the first physical channel in the case of overlapping between the DMRS for the first physical channel and the first resource.

In some embodiments, the first resource is a resource in a first time-domain range, and/or, the first resource is a resource in a first frequency-domain range.

In some embodiments, the first time-domain range is indicated or configured by a network device, or the first time-domain range is predefined by a protocol.

In some embodiments, the first frequency-domain range is indicated or configured by the network device, or the first frequency-domain range is predefined by a protocol.

In some embodiments, the method is applicable to full-duplex communication.

It may be understood that, apparatus embodiments and method embodiments may correspond to each other, and for similar illustrations, reference can be made to the method embodiments. Specifically, the terminal device 300 illustrated in FIG. 10 may correspond to a corresponding body that performs the method 200 in embodiments of the disclosure, and the foregoing and other operations and/or functions of each unit of the terminal device 300 are respectively for implementing corresponding processes of each method in FIG. 8, which will not be repeated herein for the sake of simplicity.

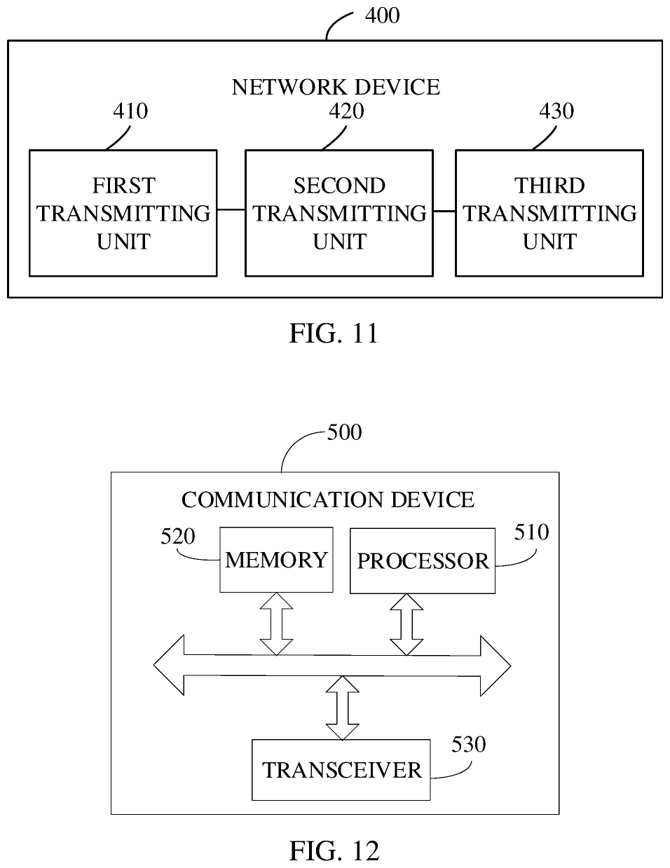

FIG. 11 is a schematic block diagram illustrating a network device 400 in embodiments of the disclosure.

As illustrated in FIG. 11, the network device 400 includes a first transmitting unit 410. The first transmitting unit 410 is configured to transmit first information. The first information is used to configure or indicate a first resource, and the first resource is not used for transmission or reception of a first physical channel.

In some embodiments, the first resource is not used for transmission or reception of the first physical channel as follows. A terminal device does not expect overlapping between the first physical channel and the first resource, or the terminal device does not expect to transmit or receive the first physical channel in the case of overlapping between the first physical channel and the first resource.

In some embodiments, the case that the first resource is not used for transmission or reception of the first physical channel includes that: the case that the first resource is not used for transmission or reception of the first physical channel is predefined by a protocol.

In some embodiments, the first physical channel is a PUSCH.

In some embodiments, the first resource includes at least one of a resource where an SSB is located, a CORESET, a resource where a CSI-RS is located, or a resource where a CRS is located.

In some embodiments, the first physical channel is a PDSCH.

In some embodiments, the first resource includes at least one of a resource where a first PUCCH is located, or an SRS resource.

In some embodiments, the resource where the first PUCCH is located includes at least one of a resource where an SR is located, a resource where HARQ-ACK is located, or a resource where CSI is located.

In some embodiments, the first resource includes a resource(s) indicated by at least one first rate-matching pattern.

In some embodiments, the first information is used to configure the at least one first rate-matching pattern.

In some embodiments, the first information indicates an index(es) of the at least one first rate-matching pattern.

In some embodiments, the network device 400 may further include a second transmitting unit 420. The second transmitting unit 420 is configured to transmit first configuration information. The first configuration information is used to configure at least one second rate-matching pattern, and the at least one second rate-matching pattern includes the at least one first rate-matching pattern.

In some embodiments, the resource indicated by the at least one first rate-matching pattern includes a resource(s) where at least one first signal is located and/or a resource(s) where at least one first channel is located.

In some embodiments, the first resource includes the resource(s) where the at least one first signal is located and/or the resource(s) where the at least one first channel is located.

In some embodiments, the first information is used to configure the resource(s) where the at least one first signal is located and/or the resource(s) where the at least one first channel is located.

In some embodiments, the first information indicates an index(es) of the at least one first signal and/or an index(es) of the at least one first channel.

In some embodiments, the network device 400 may further include a third transmitting unit 430. The third transmitting unit 430 is configured to transmit second configuration information. The second configuration information is used to configure a resource(s) for at least one second signal and/or configure a resource(s) for at least one second channel, the at least one second signal includes the at least one first signal, and the at least one second channel includes the at least one first channel.

In some embodiments, the first physical channel is a PUSCH, where the at least one first signal includes at least one of a CSI-RS or a CRS; and/or the at least one first channel includes at least one of an SSB/PBCH, or a channel carried in a CORESET.

In some embodiments, the first physical channel is a PDSCH, where the at least one first signal includes an SRS; and/or, the at least one first channel includes a second PUCCH.

In some embodiments, information carried in the second PUCCH includes at least one of an SR, HARQ-ACK, or CSI.

In some embodiments, the first information is carried in RRC signaling or DCI.

In some embodiments, the terminal device does not expect overlapping between a DMRS for the first physical channel and the first resource, or the terminal device does not expect to transmit or receive the DMRS for the first physical channel in the case of overlapping between the DMRS for the first physical channel and the first resource.

In some embodiments, the first resource is a resource(s) in a first time-domain range, and/or, the first resource is a resource(s) in a first frequency-domain range.

In some embodiments, the first time-domain range is indicated or configured by the network device, or the first time-domain range is predefined by a protocol.

In some embodiments, the first frequency-domain range is indicated or configured by the network device, or the first frequency-domain range is predefined by a protocol.

In some embodiments, the method is applicable to full-duplex communication.

It may be understood that, apparatus embodiments and method embodiments may correspond to each other, and for similar illustrations, reference can be made to the method embodiments. Specifically, the network device 400 illustrated in FIG. 11 may correspond to a corresponding body that performs the method 200 in embodiments of the disclosure, and the foregoing and other operations and/or functions of each unit of the network device 400 are respectively for implementing corresponding processes of each method in FIG. 8, which will not be repeated herein for the sake of simplicity.

The communication devices in embodiments of the disclosure are described with reference to the accompanying drawings from the viewpoint of a functional module. It can be understood that, the functional module can be implemented in the form of hardware, software, or a combination of hardware and software modules. Specifically, each operation of the method embodiments in embodiments of the disclosure can be completed an integrated logic circuit in the form of hardware or an instruction in the form of software in the processor. The operations of the methods disclosed in embodiments of the disclosure may be implemented through a hardware decoding processor, or a combination of hardware and a software module in the decoding processor. Optionally, the software module can be located in a storage medium such as a random access memory (RAM), a flash memory, a read-only memory (ROM), a programmable ROM (PROM), or an electrically erasable programmable memory, a register, and the like. The storage medium is located in a memory. The processor reads information in the memory, and completes the operations of the method embodiments described above with the hardware thereof.

For example, the receiving unit 310 or the transmitting unit 410 mentioned above may be implemented as a transceiver.

FIG. 12 is a schematic block diagram illustrating a communication device 500 provided in embodiments of the disclosure.

As illustrated in FIG. 12, the communication device 500 may include a processor 510.

The processor 510 is configured to invoke and execute computer programs stored in a memory to perform the method in embodiments of the disclosure.

As illustrated in FIG. 12, the communication device 500 may further include a memory 520.

The memory 520 is configured to store indication information, or codes or instructions executed by the processor 510. The processor 510 is configured to invoke and execute computer programs stored in the memory 520 to perform the method in embodiments of the disclosure. The memory 520 may be a separate device independent of the processor 510, or may be integrated in the processor 510.

As illustrated in FIG. 12, the communication device 500 may further include a transceiver 530.

The processor 510 can control the transceiver 530 to communicate with other devices, for example, to transmit information or data to other devices, or receive information or data from other devices. The transceiver 530 may include a transmitter and a receiver. The transceiver 530 may further include one or more antennas.

It may be understood that, various components of the communication device 500 are coupled together via a bus system. In addition to a data bus, the bus system further includes a power bus, a control bus, and a status signal bus.

It may also be understood that, the communication device 500 may be the terminal device in embodiments of the disclosure, and can implement the corresponding process implemented by the terminal device in various methods according to embodiments of the disclosure. That is, the communication device 500 in embodiments of the disclosure may correspond to the terminal device 300 in embodiments of the disclosure and may correspond to a corresponding body that performs the method 200 in in embodiments of the disclosure, which will not be repeated herein for the sake of simplicity. Similarly, the communication device 500 may be the network device in embodiments of the disclosure, and can implement the corresponding process implemented by the network device in various methods according to embodiments of the disclosure. That is, the communication device 500 in embodiments of the disclosure may correspond to the network device 400 in embodiments of the disclosure and may correspond to a corresponding body that performs the method 200 in in embodiments of the disclosure, which will not be repeated herein for the sake of simplicity.

In addition, a chip is further provided in embodiments of the disclosure.

For example, the chip may be an integrated circuit chip with signal processing capabilities and is configured to implement or perform each method, operation, and logic block diagram disclosed in embodiments of the disclosure. The chip may also be referred to as a system-level chip, a system chip, a chip system, a system-on-a-chip chip, or the like. Optionally, the chip can be applied to various communication devices, to cause a communication device installed with the chip to perform each method, operation, and logic block diagram disclosed in embodiments of the disclosure.

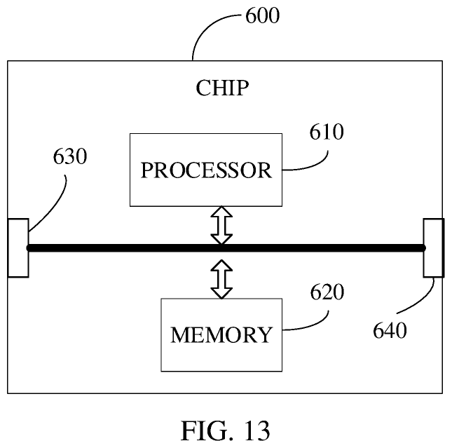

FIG. 13 is a schematic block diagram illustrating a chip 600 provided in embodiments of the disclosure.

As illustrated in FIG. 13, the chip 600 may include a processor 610.

The processor 610 is configured to invoke and execute computer programs stored in a memory to perform the method in embodiments of the disclosure.

As illustrated in FIG. 13, the chip 600 may further include a memory 620.

The processor 610 is configured to invoke and execute computer programs stored in the memory 620 to perform the method in embodiments of the disclosure. The memory 620 is configured to store indication information, or codes or instructions executed by the processor 610. The memory 620 may be a separate device independent of the processor 610, or may be integrated in the processor 610.

As illustrated in FIG. 13, the chip 600 may further include an input interface 630.

The processor 610 can control the input interface 630 to communicate with other devices or chips, for example, to obtain information or data sent by other devices or chips.

As illustrated in FIG. 13, the chip 600 may further include an output interface 640.

The processor 610 can control the output interface 640 to communicate with other devices or chips, for example, to output information or data to other devices or chips.

It can be understood that, the chip 600 can be applied to the network device in embodiments of the disclosure, and can implement the corresponding process implemented by the network device or the corresponding process implemented by the terminal device in various methods according to embodiments of the disclosure, which will not be repeated herein for the sake of simplicity.

It can be understood that, various components of the chip 600 are coupled together via a bus system. In addition to a data bus, the bus system further includes a power bus, a control bus, and a status signal bus.

The processor mentioned above may include, but is not limited to a general-purpose processor, a digital signal processor (DSP), an application specific integrated circuit (ASIC), a field programmable gate array (FPGA), or other programmable logic devices, discrete gates or transistor logic devices, discrete hardware components, etc.

The processor may be configured to implement or perform each method, operation, and logic block diagram disclosed in embodiments of the disclosure. The operations of the methods disclosed in embodiments of the disclosure may be implemented through a hardware decoding processor, or a combination of hardware and software modules in the decoding processor. The software module can be located in a storage medium such as an RAM, a flash memory, an ROM, a PROM, or an erasable programmable memory, a register, and the like. The storage medium is located in a memory. The processor reads information in the memory, and completes the operations of the method embodiments described above with the hardware thereof.

The memory mentioned above includes, but is not limited to a volatile and/or non-volatile memory. The non-volatile memory may be an ROM, a PROM, an erasable PROM (EPROM), an electrically EPROM (EEPROM), or a flash memory. The volatile memory may be an RAM that acts as an external cache. By means of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), and a direct rambus RAM (DR RAM).

The memory described herein is intended to include, but is not limited to, these and any other suitable types of memory.

A computer-readable storage medium is further provided in embodiments of the disclosure. The computer-readable storage medium is configured to store computer programs. The computer-readable storage medium is configured to store one or more computer programs including instructions which, when executed by a portable electronic device with multiple applications, cause the portable electronic device to perform the method for wireless communication provided in the disclosure. Optionally, the computer-readable storage medium can be applied to the network device in embodiments of the disclosure, and the computer programs enable a computer to perform the corresponding process implemented by the network device in various methods according to embodiments of the disclosure, which will not be repeated herein for the sake of simplicity. Optionally, the computer-readable storage medium can be applied to the mobile terminal/terminal device in embodiments of the disclosure, and the computer programs enable a computer to perform the corresponding process implemented by the mobile terminal/terminal device in various methods according to embodiments of the disclosure, which will not be repeated herein for the sake of simplicity.

A computer program product is further provided in embodiments of the disclosure. The computer program product includes computer program instructions. Optionally, the computer program product can be applied to the network device in embodiments of the disclosure and the computer programs enable a computer to perform the corresponding process implemented by the network device in various methods according to embodiments of the disclosure, which will not be repeated herein for the sake of simplicity. Optionally, the computer program product can be applied to the mobile terminal/terminal device in embodiments of the disclosure and the computer programs enable a computer to perform the corresponding process implemented by the mobile terminal/terminal device in various methods according to embodiments of the disclosure, which will not be repeated herein for the sake of simplicity.

A computer program is further provided in embodiments of the disclosure. The computer program, when running on a computer, is operable with the computer to perform the method for wireless communication provided in the disclosure. Optionally, the computer program can be applied to the network device in embodiments of the disclosure, and is operable with the computer to perform the corresponding process implemented by the network device in various methods according to embodiments of the disclosure when the computer program runs on the computer, which will not be repeated herein for the sake of simplicity. Optionally, the computer program can be applied to the mobile terminal/terminal device in embodiments of the disclosure, and is operable with the computer to perform the corresponding process implemented by the mobile terminal/terminal device in various methods according to embodiments of the disclosure when the computer program runs on the computer, which will not be repeated herein for the sake of simplicity.

A communication system is further provided in embodiments of the disclosure. The communication system may include the terminal device and the network device mentioned above, to form the communication system 100 as illustrated in FIG. 1, which will not be repeated herein for the sake of simplicity. It should be noted that, the term “system” herein may also be referred to as “network management architecture”, “network system”, etc.

It can also be understood that, the terms used in the embodiments and the claims of the disclosure are merely for describing specific embodiments rather than limiting embodiments of the disclosure. For example, the terms “a”, “the”, “said”, and the like in a singular form used in the embodiments and the claims of the disclosure are intended to include plural forms as well, unless the context clearly indicates otherwise.

Those skilled in the art should recognize that, in combination with the example units and scheme steps described in the embodiments disclosed herein, the disclosure can be implemented in electronic hardware or a combination of computer software and the electronic hardware. Whether these functions are implemented by means of the hardware or software depends on the particular application and design constraints of the technical solutions. Those skilled in the art may use different methods to implement the described functions for each particular application, but such implementation should not be considered as beyond the scope of the disclosure. The integrated unit may be stored in a computer-readable storage medium when it is implemented in the form of a software functional unit and is sold or used as a separate product. Based on such understanding, the technical solutions in embodiments of the disclosure essentially, or part of the technical solutions that contributes to the related art, or all or part of the technical solutions, may be embodied in the form of a software product which is stored in a storage medium and includes instructions for causing a computer device (which may be a personal computer, a server, or a network device and so on) to perform all or part of the steps described in the various embodiments of the disclosure. The storage medium includes various medium capable of storing program codes, such as a universal serial bus (USB) flash disk, a removable hard disk, an ROM, an RAM, a disk, compact disc (CD), or the like.

Those skilled in the art may further appreciate that, for the sake of convenience and simplicity, for the specific working processes of the foregoing systems, apparatuses, and units, reference can be made to the corresponding processes in the foregoing method embodiments, which will not be repeated herein. In several embodiments provided in the disclosure, it will be appreciated that the system, apparatuses, and the methods disclosed may also be implemented in other manners. For example, the division of units, modules, or assemblies in the above apparatus embodiments is merely a division of logical functions, and there may exist other manners of division in practice, e.g., multiple units, modules, or assemblies may be combined or may be integrated into another system, or some units, modules, or assemblies may be ignored or skipped. For another example, units/modules/assemblies illustrated as separate/display components may or may not be physically separate, i.e., may reside at one location or may be distributed to multiple network units. Some or all of the units/modules/assemblies may be selectively adopted according to practical needs to achieve desired objectives of the disclosure. It may be noted that, the coupling or direct coupling or communication connection as illustrated or discussed above may be an indirect coupling or communication connection through some interface, device or unit, and may be electrical, mechanical, or otherwise.

The above are merely specific embodiments of the disclosure and are not intended to limit the protection scope of the disclosure. Any modification and replacement made by those skilled in the art within the technical scope of the disclosure shall be included in the protection scope of the disclosure. Therefore, the protection scope of the disclosure should be stated in the protection scope of the claims.

What is claimed is:

1. A method for wireless communication, the method being applicable to a terminal device and comprising:
receiving first information, wherein the first information is used to configure a first resource or indicate the first resource, and the first resource is not used for transmission or reception of a first physical channel.

2. The method of claim 1, wherein the case that the first resource is not used for transmission or reception of the first physical channel comprises that: the terminal device does not expect overlapping between the first physical channel and the first resource, or the terminal device does not expect to transmit or receive the first physical channel in the case of overlapping between the first physical channel and the first resource.

3. The method of claim 1, wherein the case that the first resource is not used for transmission or reception of the first physical channel comprises that: the case that the first resource is not used for transmission or reception of the first physical channel is predefined by a protocol.

4. The method of claim 1, wherein the first physical channel is a physical uplink shared channel (PUSCH).

5. The method of claim 4, wherein the first resource comprises at least one of:
a resource where a synchronization signal/physical broadcast channel (SS/PBCH) block (SSB) is located, a control resource set (CORESET), a resource where a channel state information-reference signal (CSI-RS) is located, or a resource where a cell reference signal (CRS) is located.

6. The method of claim 1, wherein
the first physical channel is a physical downlink shared channel (PDSCH); and
wherein the first resource comprises at least one of:
a resource where a first physical uplink control channel (PUCCH) is located, or a sounding reference signal (SRS) resource.

7. The method of claim 1, wherein the first resource comprises at least one resource indicated by at least one first rate-matching pattern.

8. The method of claim 7, wherein the first information is used to configure the at least one first rate-matching pattern, or the first information indicates at least one index of the at least one first rate-matching pattern.

9. The method of claim 8, further comprising:
receiving first configuration information, wherein the first configuration information is used to configure at least one second rate-matching pattern, wherein the at least one second rate-matching pattern comprises the at least one first rate-matching pattern.

10. The method of claim 1, wherein the first resource comprises at least one resource where at least one first signal is located and/or at least one resource where at least one first channel is located.

11. The method of claim 10, wherein
the first information is used to configure the at least one resource where the at least one first signal is located and/or the at least one resource where the at least one first channel is located; or
the first information indicates at least one index of the at least one first signal and/or at least one index of the at least one first channel;
wherein the method further comprises: receiving second configuration information, wherein the second configuration information is used to configure at least one resource for at least one second signal and/or configure at least one resource for at least one second channel, the at least one second signal comprises the at least one first signal, and the at least one second channel comprises the at least one first channel.

12. The method of claim 10, wherein
the first physical channel is a PUSCH, wherein the at least one first signal comprises at least one of: a CSI-RS or a CRS; and/or the at least one first channel comprises at least one of: an SS/PBCH, or a channel carried in a CORESET; or
the first physical channel is a PDSCH, wherein the at least one first signal comprises an SRS; and/or, the at least one first channel comprises a second PUCCH.

13. The method of claim 1, wherein the terminal device does not expect overlapping between a demodulation reference signal (DMRS) for the first physical channel and the first resource, or the terminal device does not expect to transmit or receive the DMRS for the first physical channel in the case of overlapping between the DMRS for the first physical channel and the first resource.

14. The method of claim 1, wherein the first resource is at least one resource in a first time-domain range, and/or, the first resource is at least one resource in a first frequency-domain range.

15. The method of claim 14, wherein the first time-domain range is indicated or configured by a network device, or the first time-domain range is predefined by a protocol.

16. The method of claim 14, wherein the first frequency-domain range is indicated or configured by a network device, or the first frequency-domain range is predefined by a protocol.

17. A terminal device, comprising:
a transceiver;
a processor coupled to the transceiver; and
a memory storing computer programs which, when executed by the processor, cause the transceiver to:
receive first information, wherein the first information is used to configure a first resource or indicate the first resource, and the first resource is not used for transmission or reception of a first physical channel.

18. The terminal device of claim 17, wherein the case that the first resource is not used for transmission or reception of the first physical channel comprises that: the case that the first resource is not used for transmission or reception of the first physical channel is predefined by a protocol.

19. The terminal device of claim 17, wherein the first resource is at least one resource in a first time-domain range, and/or, the first resource is at least one resource in a first frequency-domain range.

20. A network device, comprising:
a transceiver;
a processor coupled to the transceiver; and
a memory storing computer programs which, when executed by the processor, cause the transceiver to:
transmit first information, wherein the first information is used to configure a first resource or indicate the first resource, and the first resource is not used for transmission or reception of a first physical channel.
